(19) United States
(12) Patent Application Publication
(10) Pub. No.: US 2017/0319015 A1
(43) Pub. Date: Nov. 9, 2017

(54) Cleaning Systems Including Dampened Tissues and Methods of Its Use

(71) Applicant: Olive J. Umeh, Palmdale, CA (US)

(72) Inventor: Olive J. Umeh, Palmdale, CA (US)

(21) Appl. No.: 15/147,616

(22) Filed: May 5, 2016

(51) Int. Cl. A47K 7/03; A47L 13/17; A47L 17/00; B08B 1/00

(52) U.S. Cl. CPC A47K 7/03; B08B 1/006; A47L 13/17; A47L 17/00

(57) ABSTRACT

Disclosed herein are cleaning system and personal hygience maintaining system and methods of their use. A cleaning system includes a number of plies of dampened tissue papers arranged in a pre-defined shape and size. The cleaning system also includes a protective covering configured to enclose the plies of dampened tissue papers. The protective covering is configured to protect dampness of the enclosed plies of dampened tissue papers. The protective covering also includes an opening from where at least one of the plies of dampened tissue papers is pulled out for use.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

At least some embodiments disclosed herein relate, in general, to cleaning systems including tissues and methods of its use and more specifically to an improved personal hygiene maintaining system including a number of plies of dampened tissues and a protective cover.

### BACKGROUND

Nowadays tissue papers find utility almost everywhere such as, but not limiting to, restaurants, offices, homes, and so forth, typically for cleaning purposes. Usually, in kitchen tissue papers are being used to clean utensils, vegetables, fruits, kitchen counters, etc. In day-to-day life, people also use tissue papers for wiping their hands, face, and other body parts for maintaining personal hygiene. The tissue papers are available in various sizes and shapes depending on their application.

At times, for cleaning hands, body parts, person may consume multiple tissue papers. And some times, still the body part is not cleaned properly and some residues are left behind. For example, after using restroom, the person may find himself cleaning and wiping over and over until the tissues are nearly exhausted. Sometimes, the body part may not get clean thoroughly resulting into staining or soiling of clothes or other body parts.

In light of above discussion, there exist need for improved personal hygiene maintaining systems and methods to enable better cleaning.

### SUMMARY

This Summary is provided to introduce a selection of concepts in a simplified form that are further described below in the Detailed Description. This Summary is not intended to identify key features or essential features of the claimed subject matter, nor it is intended to be used to limit the scope of the claimed subject matter.

Disclosed herein are various embodiments of the present disclosure providing cleaning systems and methods of its use for maintaining personal hygiene. Improved cleaning system and personal hygiene maintaining systems including a number of plies of dampened tissue papers are disclosed in the present disclosure. The cleaning system and personal hygiene maintaining systems enables efficient cleaning of body parts when used in restrooms, and can be used for cleaning utensils when used in kitchen.

An aspect of the present disclosure provides a cleaning system.

Another aspect of the present disclosure provides a method of maintaining personal hygiene by using a cleaning system.

A yet another aspect of the present disclosure provides a personal hygiene maintaining system.

According to an aspect of the present disclosure, a cleaning system is provided. In an embodiment, the cleaning system includes a number of plies of dampened tissue paper of a pre-defined shape and size. The cleaning system also includes a protective covering configured to enclose the plies of dampened tissue. The protective covering is configured to protect dampness of the enclosed plies of dampened tissue papers. The protective covering comprising an opening from where at least one of the plies of dampened tissue papers is pulled out for use.

According to another embodiment of the present disclosure, a method of maintaining personal hygiene by using a cleaning system is provided. The method includes providing a number of plies of dampened tissue papers of a pre-defined shape and size. The method further includes providing a protective covering configured to enclose the plies of dampened tissue papers. The protective covering is configured to protect dampness of the enclosed plies of dampened tissue papers. The protective covering further comprises opening. The method further includes pulling out at least one of the plurality of plies of the dampened tissue papers from the opening for use.

According to a yet another aspect of the present disclosure, a personal hygiene maintaining system. The personal hygiene maintaining system includes a number of plies of dampened tissue papers of a pre-defined shape and size. The personal hygiene maintaining system includes a protective covering configured to enclose the plies of dampened tissue. The protective covering is configured to protect dampness of the enclosed plies of dampened tissue papers. The protective covering comprising an opening from where at least one of the plies of dampened tissue papers is pulled out for use.

In one embodiment, the plies of dampened tissue papers includes a number of interconnected plies of dampened tissues.

In an embodiment, a material used for making the plurality of plies of dampened tissue papers comprises soft wood, and hard wood.

In an embodiment, cleaning system also includes a handle, wherein the plies of dampened tissue papers are capable of being inserted into the handle.

In one embodiment, the plies of the dampened tissue papers comprises interconnected rectangular ply of dampened tissue papers arranged in a shape of a cylindrical roll.

In some embodiments, the protective covering is cylindrical hollow protective covering capable of being inserted into the handle and comprises the opening.

In an embodiment, a shape and a size of the protective covering is in accordance with a shape and size of the plurality of plies of dampened tissue papers.

Further, in an embodiment, the protective covering is formed using at least one of a wood, metal, plastic, and cardboard.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIG. 1 is a front view of a cleaning system, in accordance of an embodiment of the present disclosure;

FIG. 2 is a back view of the cleaning system of FIG. 1, in accordance of an embodiment of the present disclosure;

FIG. 3 is an illustration of a roll including a number of plies of dampened tissue papers, in accordance of an embodiment of the present disclosure; and

FIG. 4 is a flowchart illustrating a method of maintaining personal hygiene by using the cleaning system of FIG. 1, in accordance with an embodiment of the present disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

According to an aspect of the present disclosure a cleaning system comprising: a plurality of plies of dampened tissue papers arranged in a pre-defined shape and size; and a protective covering configured to enclose the plurality of plies of dampened tissue papers, wherein the protective covering is configured to protect dampness of the enclosed plurality of plies of dampened tissue papers, further wherein the protective covering further comprises an opening from where at least one of the plurality of plies of dampened tissue papers is pulled out for use.

According to another aspect of the present disclosure, a method of maintaining personal hygiene by using a cleaning system, comprising: providing a plurality of plies of dampened tissue papers arranged in a pre-defined shape and size; providing a protective covering configured to enclose the plurality of plies of dampened tissue papers, the protective covering is configured to protect dampness of the enclosed plurality of plies of dampened tissue papers, the protective covering further comprises an opening; and pulling out at least one of the plurality of plies of the dampened tissue papers from the opening for use.

According to yet another embodiment of the present disclosure, a personal hygiene maintaining system comprising a plurality of plies of dampened tissue papers arranged in a pre-defined shape and size; and a protective covering configured to enclose the plurality of plies of dampened tissue papers, wherein the protective covering is configured to protect dampness of the enclosed plurality of plies of dampened tissue papers, further wherein the protective covering further comprises an opening from where at least one of the plurality of plies of dampened tissue papers is pulled out for use.

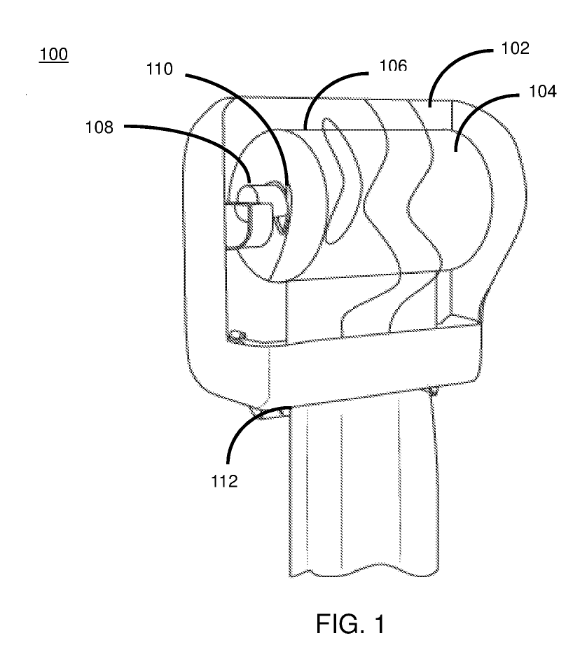

Referring now to FIG. 1, a front view 100 of a cleaning system 102 is shown, in accordance of an embodiment of the present disclosure. As shown, the cleaning system 102 primarily includes a number of plies of dampened tissue papers 104 arranged in a pre-defined shape and size and a protective covering 106. The cleaning system 102 is a personal hygiene maintaining system that can be used by a user for wiping his/her hands, face, or other body parts. The cleaning system 102 may also be used in kitchens for cleaning vegetables, fruits, kitchen counter surface, and so forth. In an embodiment, the plies of dampened tissue papers 104 include a number of interconnected plies of dampened tissues including one or more layers of dampened tissue papers. The plies of the dampened tissue papers may include wet tissues arranged in form of a roll. Further, a material used for making the plies of dampened tissue papers includes soft wood, and hard wood. Examples of the material of the dampened tissue papers include, but are not limited to, paper pulp, cellulosic fiber pulp, and so forth.

Further, the plies of the dampened tissue papers are impregnated with a dampening material such as, but not limiting to, water. In an embodiment, the plies of the dampened tissue papers are arranged in shape of a cylindrical roll.

In an embodiment, the cleaning system 102 also includes a handle 108. The cylindrical roll may include a hole 110. The cylindrical roll of plies of the dampened tissue papers 104 is capable of being inserted into the handle 108 via the hole 110. In an embodiment, the plies of the dampened tissue papers are flushable and can be used to wipe a body part such as, but not limiting to, face, anus, hands, and so forth, without leaving any residue. Further, due to dampness the body part may get clean with limited number of plies of dampened tissue papers.

The protective covering 106 is configured to enclose the plies of dampened tissue papers 104. The protective covering 106 may protect dampness of the enclosed plies of dampened tissue papers 104. The protective covering 106 further includes an opening 112 from where at least one of the plies of dampened tissue papers is pulled out for use. Further, in an embodiment, a shape and a size of the protective covering 106 is in accordance with a shape and size of the plies of dampened tissue papers 104. In an embodiment, the protective covering 106 is a cylindrical hollow protective covering capable of being inserted into the handle 108 and includes the opening 112. Further, the protective covering 106 may be formed using a suitable material including at least one of a wood, metal, plastic, and cardboard. The protective covering 106 may protect dampness of the plies of the dampened tissue papers by preventing them from drying out. In an embodiment, each ply may be protected from drying up by wrapping it all around from “one-ply all the way up to six-ply”.

In an example, the user may pull out at least one ply of the plies of dampened tissues from the cleaning system 102 after using the restroom for cleaning his/her anus. The wetness or dampness of the tissue papers ensures effective cleaning of the body part with use of minimum number of plies of dampened tissue papers 104.

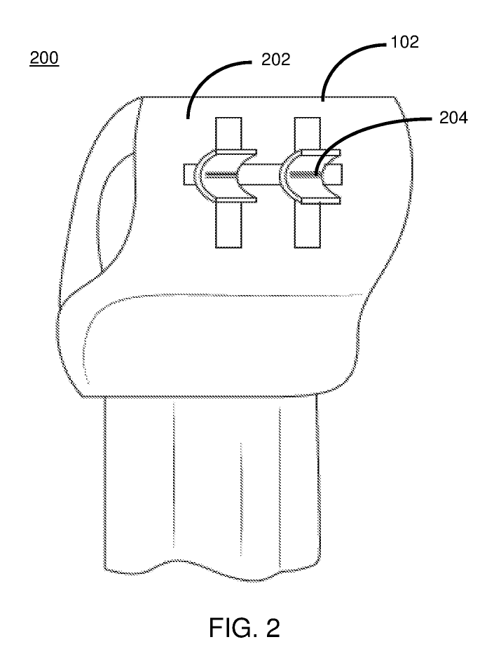

FIG. 2 is a back view 200 of the cleaning system 102 of FIG. 1, in accordance of an embodiment of the present disclosure. As shown, the backside of the cleaning system 102 includes one or more attachment units 204 configured to hang the cleaning system 102 on a surface such as a wall. In an embodiment, the surface is a flat regular surface. In an alternative embodiment, the surface is an irregular surface. Further, the one or more attachment units 204 may include one or more holes for enabling hanging of the cleaning system 102 in one or more nails fixed on the surface. Alternatively, the one or more attachment units 204 may slide horizontally into a horizontal rod like structure fixed into the surface. In an embodiment, the one or more attachments are configured to be fixed on irregular surface.

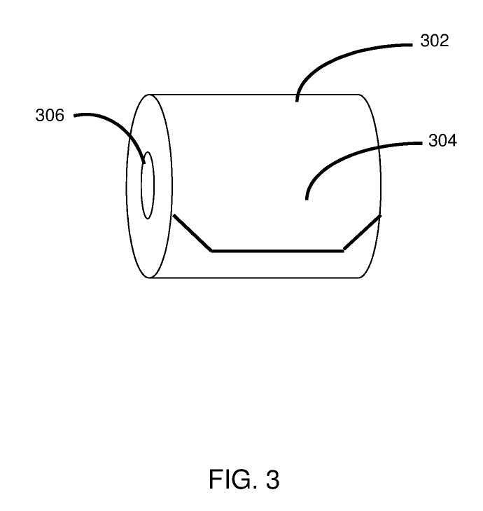

FIG. 3 is an illustration of an exemplary roll 302 including a number of plies of dampened tissue papers 304, in accordance of an embodiment of the present disclosure. In an embodiment, a shape and size of the roll 302 is same, as that of rolls of tissue papers currently known in the art. The roll 302 may include interconnected plies of the dampened tissue papers 304. The roll 302 may be a cylindrical roll. The roll 302 may include a hole 306. The roll 302 including multiple interconnected plies of the dampened tissue papers 304 is capable of being inserted into the handle 108 via the hole 306 as discussed with reference to FIG. 1.

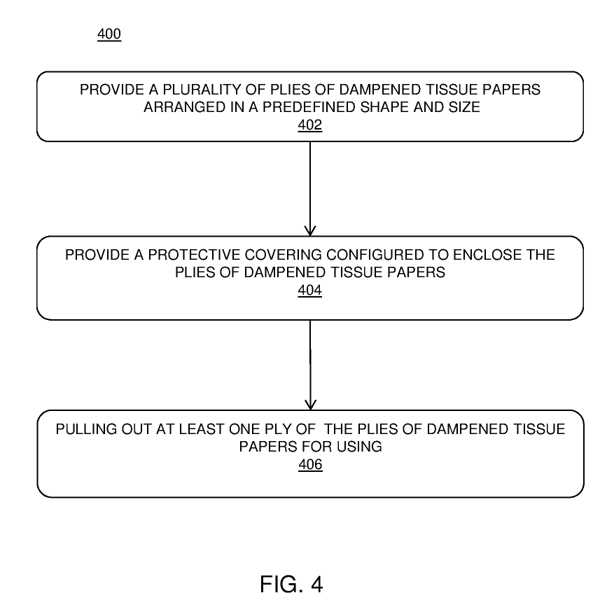

FIG. 4 is a flowchart illustrating a method 400 of maintaining personal hygiene by using the cleaning system 102 of FIG. 1, in accordance with an embodiment of the present disclosure. At step 402, a number of plies of dampened tissue papers arranged in a pre-defined shape and size. In one embodiment, the plies of dampened tissue papers are arranges in shape of a cylindrical roll. At step 404, a protective covering configured to enclose the plies of the dampened tissue papers is provided. Then at step 406, a user pulls out at least one ply of the plies of the dampened tissue papers for using. The plies of the dampened tissue papers can be used in restrooms, kitchen, hotels, etc. for wiping body parts, objects, etc.

The disclosed cleaning system (or personal hygiene maintaining system) can help people to maintain personal hygiene. The disclosed cleaning system may also save money because after using the restroom, the person may be able to clean himself/herself by using one or two plies of dampened tissue papers without leaving any residues, hence there will be no soiling or staining of his/her underwear. As cleaning or wiping is possible with the use of less number of disclosed dampened tissue papers. Therefore, it will result in saving money of consumer buying the cleaning system.

Everyone including babies, adults can use the disclosed cleaning system including the dampened tissue papers. The disclosed dampened tissue papers may be used as hand wipes or facial wipes. Further, the plies of the dampened tissue papers may be used for cleaning surface or counters in the kitchen, homes, restaurants etc.

In one embodiment, the plies of dampened tissue papers include a protective covering for protecting the wetness or dampness of the plies of the dampened tissue papers. The dampened tissue papers are configured to decompose in septic tanks. In alternative embodiments, when the plies of the dampened tissue papers are used as surface or counter top cleaners and facial tissues, then the dampened tissue papers are not made to decompose. Further, the plies of the dampened tissue papers are arranged as single sheets or alternatively as multiple sheets.

In an exemplary scenario, one or more of the plies of the dampened tissue papers can be used for cleaning the anus and that area after defecating and being completely rid of stains or residues. After answering the nature's call, a user may thoroughly clean by wiping the body part (i.e. the anus) and rest assured that all residues will be removed completely.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A cleaning system comprising:
a. a plurality of plies of dampened tissue papers arranged in a pre-defined shape and size; and
b. a protective covering configured to enclose the plurality of plies of dampened tissue papers, wherein the protective covering is configured to protect dampness of the enclosed plurality of plies of dampened tissue papers, further wherein the protective covering further comprises an opening from where at least one of the plurality of plies of dampened tissue papers is pulled out for use.

2. The cleaning system of claim 1, wherein the plurality of plies of dampened tissue papers comprises a plurality of interconnected plies of dampened tissue papers.

3. The cleaning system of claim 2, wherein a material used for making the plurality of plies of dampened tissue papers comprises soft wood, and hard wood.

4. The cleaning system of claim 3 further comprising a handle, wherein the plurality of plies of dampened tissue papers is capable of being inserted into the handle.

5. The cleaning system of claim 4, wherein the plurality of plies of the dampened tissue papers comprises interconnected rectangular ply of dampened tissue papers arranged in a shape of a cylindrical roll.

6. The cleaning system of claim 5, wherein the protective covering is cylindrical hollow protective covering capable of being inserted into the handle and comprises the opening.

7. The cleaning system of claim 6, wherein a shape and a size of the protective covering is in accordance with a shape and size of the plurality of plies of dampened tissue papers.

8. The cleaning system of claim 7, wherein the protective covering is formed using at least one of a wood, metal, plastic, and cardboard.

9. A method of maintaining personal hygiene by using a cleaning system, comprising:
a. providing a plurality of plies of dampened tissue papers arranged in a pre-defined shape and size;
b. providing a protective covering configured to enclose the plurality of plies of dampened tissue papers, wherein the protective covering is configured to protect dampness of the enclosed plurality of plies of dampened tissue papers, further wherein the protective covering further comprises an opening; and
c. pulling out at least one of the plurality of plies of the dampened tissue papers from the opening for use.

10. A personal hygiene maintaining system comprising:
a. a plurality of plies of dampened tissue papers arranged in a pre-defined shape and size; and
b. a protective covering configured to enclose the plurality of plies of dampened tissue papers, wherein the protective covering is configured to protect dampness of the enclosed plurality of plies of dampened tissue papers, further wherein the protective covering further comprises an opening from where at least one of the plurality of plies of dampened tissue papers is pulled out for use.

11. The personal hygiene maintaining system of claim 10, wherein the plurality of plies of dampened tissue papers comprises a plurality of interconnected plies of dampened tissue papers.

12. The personal hygiene maintaining system of claim 11, wherein a material used for making the plurality of plies of dampened tissue papers comprises soft wood, and hard wood.

13. The personal hygiene maintaining system of claim 12, wherein the protective covering is capable of being inserted into a handle.

14. The personal hygiene maintaining system of claim 13, wherein the plurality of plies of the dampened tissue papers comprises interconnected rectangular ply of dampened tissue papers arranged in a shape of a roll.

15. The personal hygiene maintaining system of claim 14, wherein the protective covering is cylindrical hollow protective covering capable of being inserted into the handle and comprises the opening from where one or more plies of the dampened tissue papers are pulled out.

16. The personal hygiene maintaining system of claim 15, wherein a shape and a size of the protective covering is in accordance with a shape and size of the plurality of plies of dampened tissue papers.

17. The personal hygiene maintaining system of claim 16, wherein the protective covering is formed using at least one of a wood, metal, plastic, and cardboard.
